(19) United States
(12) Patent Application Publication
(10) Pub. No.: US 2021/0209518 A1
(43) Pub. Date: Jul. 8, 2021

(54) PEER TO PEER RENTAL RESERVATIONS

(71) Applicant: Carrier Corporation, Palm Beach Gardens, FL (US)

(72) Inventors: Steve Switzer, Atlanta, GA (US); Adam Kuenzi, Silverton, OR (US)

(21) Appl. No.: 17/072,107

(22) PCT Filed: Apr. 18, 2019
(86) PCT No.: PCT/US2019/028116

§ 371 Date: Oct. 16, 2020

Related U.S. Application Data
(60) Provisional application No. 62/660,061, filed on Apr. 19, 2018.

(51) Int. Cl. G06Q 10/02; G06Q 30/08; G06F 16/27

(52) U.S. Cl. CPC G06Q 10/02; G06F 16/27; G06Q 30/08

(57) ABSTRACT

Methods and systems for access control are provided. Aspects include storing, in a server, a distributed database that includes a plurality of data records, wherein the plurality of data records comprise rental data associated with rental items. An access request is received for access to the rental data, wherein the rental data includes a price minimum and an availability for each of a plurality of rental locations. An identity of the requestor is authenticated. A transaction record is generated including the identity of the requestor. Access is provided to the rental data. Bid data is received for a first rental location from the plurality of rental locations, wherein the bid data includes an ask price for the first rental location. And the ask price is compared to the price minimum associated with the first rental location to determine an action for the first rental location.

### CROSS-REFERENCE TO RELATED APPLICATIONS

This application claims the benefit of U.S. Provisional Patent Application No. 62/660,061 filed Apr. 19, 2018 and International Patent Application No. PCT/US19/028116 filed Apr. 18, 2019, which is incorporated herein by reference in its entirety.

### BACKGROUND

Exemplary embodiments pertain to the art of peer-to-peer networking and more specifically to peer-to-peer rental reservations.

A peer-to-peer network is a distributed application architecture that can partition tasks. Peer-to-peer architectures can be applied to a variety of applications including distributed databases such as block chains. The data received for storage in the block chain can be configured to be processed to generate a transaction record that is dependent on previous data stored to the block chain. The transaction record being dependent on previous data stored to the block chain ensures that data stored to the block chain is not modifiable, as each later data stored to the block chain continues to be dependent on previous data stored to the block chain.

Current reservation systems have drawbacks ranging from third party consolidators that heavily discount rooms and rental rates to expensive infrastructure for small companies or individuals wishing to rent rooms, homes, apartments, and the like. There exists a need for a peer-to-peer, secure marketplace for rental reservations.

### BRIEF DESCRIPTION

According to one embodiment, a computer-implemented method is provided. The method includes storing, in a server, a distributed database that includes a plurality of data records, wherein the plurality of data records comprise rental data associated with rental items. An access request is received for access to the rental data, wherein the rental data includes a price minimum and an availability for each of a plurality of rental locations. An identity of the requestor is authenticated. A transaction record is generated including the identity of the requestor. Access is provided to the rental data. Bid data is received for a first rental location from the plurality of rental locations, wherein the bid data includes an ask price for the first rental location. And the ask price is compared to the price minimum associated with the first rental location to determine an action for the first rental location.

In addition to one or more of the features described above, or as an alternative, further embodiments of the method may include that the distributed database is a block chain that receives data from a plurality of entities, the data received for storage is configured to be processed to generate a transaction record that is dependent on previous data stored in the block chain.

In addition to one or more of the features described above, or as an alternative, further embodiments of the method may include that the action includes accepting the ask price and requesting payment data from the requestor. Receiving, from the requestor, payment data for the first rental location. Adding the bid data and the payment data to the transaction record and storing the transaction record in the distributed database.

In addition to one or more of the features described above, or as an alternative, further embodiments of the method may include that the action comprises rejecting the ask price in the bid data based on a determination that the ask price is less than the price minimum associated with the first rental location.

In addition to one or more of the features described above, or as an alternative, further embodiments of the method may include that the action includes transmitting a price override request to a manager of the first rental location based on a determination that the ask price was less than the price minimum associated with the rental location. Receiving a confirmation of the price override request from the manager and requesting payment data from the requestor. Receiving, from the requestor, payment data for the first rental location. Storing the bid data and the payment data in the transaction record and storing the transaction record in the distributed database.

In addition to one or more of the features described above, or as an alternative, further embodiments of the method may include transmitting the transaction record to the requestor and to an internet-of-things (IoT) device associated with the first rental location.

In addition to one or more of the features described above, or as an alternative, further embodiments of the method may include that the IoT device is an electronic lock at the first rental location.

In addition to one or more of the features described above, or as an alternative, further embodiments of the method may include that the requestor can unlock the electronic lock based on a verification of the identity of the requestor by the electronic lock.

In addition to one or more of the features described above, or as an alternative, further embodiments of the method may include transmitting a token to the requestor and the IoT device, wherein the token authenticates the requestor.

In addition to one or more of the features described above, or as an alternative, further embodiments of the method may include that the transaction record includes requestor preference data.

According to one embodiment, a system is provided. The system includes a processor communicatively coupled to a server, the processor operable to: store, in the server, a distributed database that includes a plurality of data records, wherein the plurality of data records include rental data associated with rental items. Receive, from a requestor, an access request for access to the rental data, wherein the rental data includes a price minimum and an availability associated with each of a plurality of rental locations. Authenticate an identity of the requestor and generate a transaction record comprising the identity of the requestor. Provide, to the requestor, access to the rental data. Receive, from the requestor, bid data for a first rental location, wherein the bid data includes an ask price for the first rental location and compare the ask price to the price minimum associated with the first rental location to determine an action for the first rental location.

In addition to one or more of the features described above, or as an alternative, further embodiments of the system may include that the distributed database is a blockchain that receives data from a plurality of entities, the data received for storage is configured to be processed to generate a transaction record that is dependent on previous data stored in the blockchain.

In addition to one or more of the features described above, or as an alternative, further embodiments of the system may include that the action includes accepting the ask price and requesting payment data from the requestor; and the processor is further operable to: receive, from the requestor, payment data for the first rental location, add the bid data and the payment data to the transaction record, and store the transaction record in the distributed database.

In addition to one or more of the features described above, or as an alternative, further embodiments of the system may include that the action comprises rejecting the ask price in the bid data based on a determination that the ask price is less than the price minimum associated with the first rental location.

In addition to one or more of the features described above, or as an alternative, further embodiments of the system may include that the action comprises transmitting a price override request to a manager of the first rental location based on a determination that the ask price was less than the price minimum associated with the rental location; and the processor is further operable to: receive a confirmation of the price override request from the manager and requesting payment data from the requestor, receive, from the requestor, payment data for the first rental location, store the bid data and the payment data in the transaction record, and store the transaction record in the distributed database.

In addition to one or more of the features described above, or as an alternative, further embodiments of the system may include that the processor is further operable to: transmitting the transaction record to the requestor and to an internet-of-things (IoT) device associated with the first rental location.

In addition to one or more of the features described above, or as an alternative, further embodiments of the system may include that the IoT device is an electronic lock at the first rental location.

In addition to one or more of the features described above, or as an alternative, further embodiments of the system may include that the requestor can unlock the electronic lock based on a verification of the identity of the requestor by the electronic lock.

According to one embodiment, a method is provided. The method includes storing, in a memory of a processing server, a distributed database that includes a plurality of data records. Receiving, from a publisher, a request to store a new record to the distributed database. Verifying an identity of the publisher and based at least in part on verifying the identity of the publisher, storing the new record to the plurality of data records of the distributed database.

In addition to one or more of the features described above, or as an alternative, further embodiments of the method may include that the distributed database is a block chain that receives data from a plurality of entities, the data received for storage is configured to be processed to generate a transaction record that is dependent on previous data stored in the block chain.

### BRIEF DESCRIPTION OF THE DRAWINGS

The following descriptions should not be considered limiting in any way. With reference to the accompanying drawings, like elements are numbered alike:

FIG. 1 depicts a block diagram of a computer system for use in implementing one or more embodiments;

FIG. 2 depicts a diagram of a system for access control according to embodiments; and

FIG. 3 depicts a flow chart of a method access control according to one or more embodiments.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

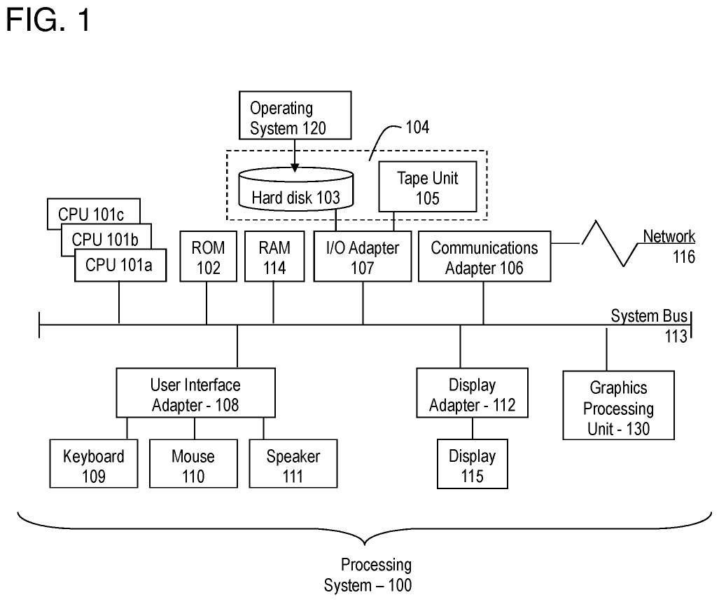

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 1.

Turning now to an overview of technologies that are more specifically relevant to aspects of the disclosure, current hospitality and peer-to-peer reservation systems can have multiple drawbacks. For example, for branded hospitality systems, there are third party consolidators that have agreements in place that can take up to a 30% discount from small hospitality organizations. In addition to the sharp discounts, these reservation systems are not connected and reservations are transmitted manually. In the case of a small independent hospitality company, infrastructure costs can be a consideration as it can be expensive to implement and connect into a centralized reservation system. Also, management of centralized credit transactions can be a problem. There exists a need for a peer-to-peer system that allows for individuals and organizations looking to rent out anything from hotel rooms, homes, and vehicles to publish rental data to a distributed database for access by customers.

Turning now to an overview of the aspects of the disclosure, one or more embodiments address the above-described shortcomings of the prior art by providing a system for peer-to-peer hotel reservations. Aspects include a distributed database integrated trust delegation that provides authentic information about the state of rental reservations and rental surplus for individuals or organizations. Internet of things (IoT) devices associated with the rental location can be utilized to provide access to a customer looking to rent. For example, an electronic lock can communicate with the distributed database to verify a customer has rented a room and for how long. Once the customer's identity if verified, the electronic lock can be unlocked remotely allowing access to the room or house. Or the electronic lock can be unlocked by the customer using a token or key downloaded on to their smartphone or other device.

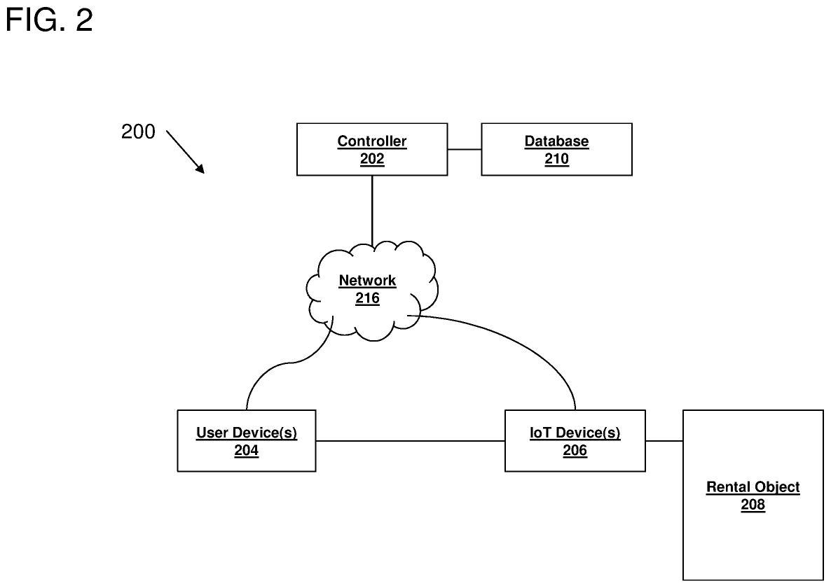

Turning now to a more detailed description of aspects of the present disclosure, FIG. 2 depicts a diagram of a system for access control to rental objects according to one or more embodiments. The system 200 includes a controller 202, a user device 204, an IoT device 206, a rental object 208, a database 210, and a network 216.

In one or more embodiments, the controller can be implemented on the processing system 100 found in FIG. 1. Additionally, the network 216 can be utilized for electronic communication between and among the controller and other devices. The network 216 can be in wired or wireless electronic communication with one or all of the elements of the system 200. Cloud computing can supplement, support or replace some or all of the functionality of the elements of the system 200. Additionally, some or all of the functionality of the elements of system 200 can be implemented as a cloud computing node. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

In one or more embodiments, the system 200 provides access to rental objects 208 for users. The rental objects 208 include, but are not limited to, hotel rooms, houses, apartments, vehicles, and the like. The system 200 operates as a peer-to-peer reservation system where users can upload details about rental objects such as availability, location, room type, retail rate, property information, and the like. The rental data is stored in the database 210 and indexed so that a potential customer (renter) can search the index to find available rental objects 208 that meet the search criteria. For example, a user might wish to search for a hotel room in June of this year located in Seattle. For the user to search the database 210, the user would utilize a user device 204, such as a smartphone or tablet, and send a request to a controller 202 for access to the rental data stored on the database 210. The request can include authentication information about the user to confirm the identity of the user. Once the user's identity is confirmed, the user can then access the database 210 and search for rental objects 208 (e.g., hotel rooms, rental vehicles, etc.).

In one or more embodiments, once a user has identified a rental object 208, the user can submit a bid to the controller 202. Based on the price in the bid, the controller 202 can either accept the bid, reject the bid, or forward the bid to a manager of the rental object. For example, if a bid for a hotel room is less than the price minimum established by the hotel manager but within a certain threshold, the controller 202 could send the bid information to the manager to override the price minimums included in the rental data about the rental object 208 (i.e., hotel room). When the bid is accepted, a transaction record is generated and stored in the distributed database 210. The transaction record includes the identity of the user along with reservation data associated with the rental object 208. The user would then submit payment information to a third party payment server. Payment can be confirmed by the third party payment server and submitted to the database to be stored in the transaction record or in an additional transaction record.

In one or more embodiments, the IoT device 206 can be an electronic lock for the rental object 208 that allows access to the rental object 208. The transaction record is stored in the database 210 which can be accessed by the IoT device 206. A customer, once verified by the IoT device 206, can access the rental object 208 (e.g., hotel room or apartment). The IoT device 206 can access the database to obtain transaction record or the IoT device 206 can be sent the transaction record including a customer identity along with reservation information such as rental duration. The term Internet of Things (IoT) device is used herein to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet.

In one or more embodiments, the database 210 can be a distributed database such as a block chain. A block chain is a decentralized, distributed and public digital ledger that is used to record transactions across many computers so that the record cannot be altered retroactively without the alteration of all subsequent blocks and the collusion of the network. This allows the participants to verify and audit transactions inexpensively. A block chain database is managed autonomously using a peer-to-peer network and a distributed timestamping server. They are authenticated by mass collaboration powered by collective self-interests (e.g., customers, hotel owners, etc.).

The block chain structure enables users' access to securely store data in a public place. The data is deemed secure, as each time data is written, the written data is dependent on previously written data, which includes performing cryptographic hash operations. A benefit of using a block chain is that once data is written to the block chain and a block chain transaction is created, that transaction remains intact, and can be verified in the future. The reason for this, is that data is continually written to the block chain, e.g., after a particular transaction is made, and that later data is dependent on an earlier particular transaction. Consequently, by writing data to a public storage facility that implements a public block chain, later verification of that data is practically ensured to be correct.

The block chain can ensure the integrity of transaction information. For a public block chain, the entities that are posting to the blockchain can be virtually anyone. Therefore identification and authentication of the entity that posted a transaction to the blockchain is important. Identification and authentication can be done by including identifiers in the blockchain record that indicate who created the record, who provided which part of the record. (i.e., if someone places a bid, who submitted the bid? if someone accepts the bid, who accepted it? if someone included identification information for the guest reserving the hotel room, who is the guest and who submitted the information on behalf of the guest?). Systems that then consume the block chain record would indicate whether additional transactions were done on top. For example, was the payment remitted? Are access rights being granted? Is the reservation bid accepted/rejected? The IoT device or controller 202 can review all of these transaction inputs and verify the identities before allowing access to the rental object 208. Verifying identities can include verifying digital signatures that are contained inside of a transaction record that are separate from the actual block-chain mechanism that ensures a transaction record on the chain is kept intact and is verified as being intact.

In one or more embodiments, access to the blockchain may be limited to specific controllers 202—in this sense it is a public blockchain but only public to a limited set of controllers who are allowed to record to the blockchain. The controllers are managed by entities in the rental market who know each other and can identify each other by their respective controllers. The controllers record transactions using digital signatures to provide verifiability that a particular controller did indeed create a transaction. An IoT device may be pre-configured to ONLY accept authorized transactions from a particular controller that they are associated with so that the IoT device has a public key for the controller and can verify the controller's digital signatures made with the controller's private key. This way the IoT device only needs to know one public key.

In one or more embodiments, there may be one or multiple block chains. One blockchain may be designated for handling the rental and payment transactions. Another blockchain may be designated for granting/recording access rights and access information. The User device 204 may access the controller for the first block chain to get information on availability of rental objects 208. The user device can receive an input from a user which then places a bid. The bid can be accepted by either the IoT device 206 or a manager of the rental object 208 based on the bid. A transaction record is written to a second block chain to record access rights. The IoT device 206 may access the controller 202 to confirm from the second blockchain that the access rights are correct. Based on confirming the access rights, the IoT device 206 can allow access by the user device 204.

In one or more embodiments, the blockchain can be a private block chain. A private (or closed) blockchain is permissioned. That is to say, the private block chain is managed centrally by an entity where participants are only allowed access to the block chain by a business relation (e.g., hotel managers, apartment owners, and the like).

In one or more embodiments, a rental object 208 owner and a potential customer are verified by the database 210 or by a third party verification server prior to gaining access to the database 210. Once verified, an owner 208 can publish rental data to the database 210 regarding one or more rental objects 208 the owner wishes to rent to the public. This peer-to-peer relationship reduces costs for the owner and potential customer. Additionally, the block chain structure allows for security and verification of this public marketplace for rental objects 208. Each time an owner publishes rental data, the rental data is added to the block chain. When a customer completes a transaction, the transaction record is added to the block chain, as well. The block chain or a portion of the block chain (e.g., the transaction record) can be distributed to the customer and to the IoT device 206 associated with the rental object 208.

In one or more embodiments, during the reservation period, the customer and IoT device 206 can establish a trusted relationship which allows the customer to access the rental object 208. The trusted relationship can be established through the use of a token and/or key that the customer can provide to the IoT device 206 and verified by accessing the block chain. Other methods of establishing the trusted relationship can include a customer logging in to a social network or other website to establish the customer's identity. For example, a customer can supply their social networking identity as part of the transaction. Then, when the customer accesses the IoT device 206, they can authenticate to their social network account which then supplies a verifiable token that can be provided to the IoT device 206 that confirms the customer's identity. The IoT device 206 can trust, for example, existing social media websites and can verify a certificate from the site indicating that this identity is authenticated. The certificate could be time-bound and must be recent to avoid copying and reuse.

In one or more embodiments, another authentication method can be to provide a hash of an authentication input. The hash is stored with the transaction. The IoT device 206 will perform the hash on a second input provided from the user device 204 to the IoT device 206. If the resulting hash matches the hash stored in the transaction then the customer is deemed to be authentic. The input could be a password, a PIN, an identity, etc. that is controlled by the user of the user device 204 so that they are the only ones that can prove their identity. Since the public block chain is public anyone can see the “hash” but they cannot reverse back to find the actual input for creating the hash. Hash functions are cryptographic operations that provide a 1-way function. The same input into a hash function produces the same output and no two inputs map to the same output. An example hash function is the SHA-256 hash function.

In one or more embodiments, a customer can enter or have stored on the user device 204 preference data that is included in the block chain. This preference data can include preferences for the particular customer such as, for example, temperature settings, smoking preference, pillow or comforter type, and the like.

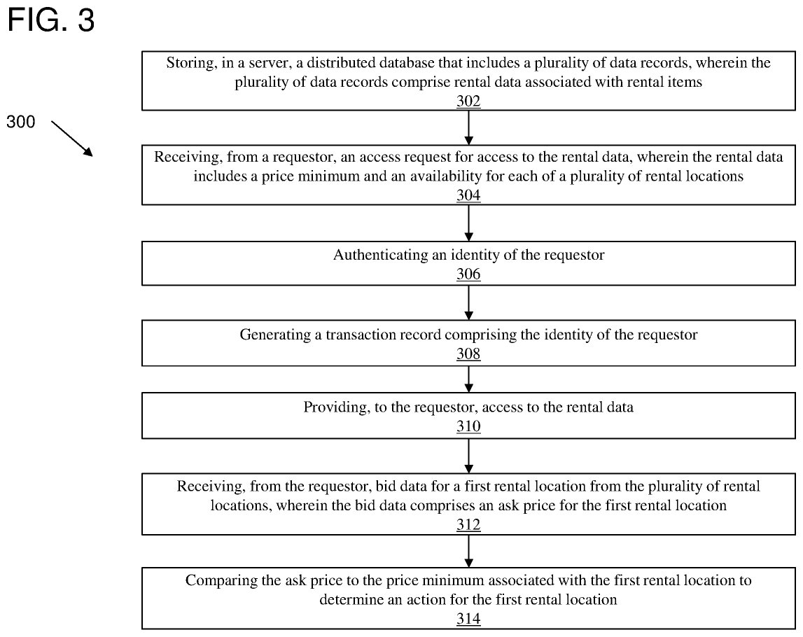

FIG. 3 depicts a flow chart of a method for access control according to one or more embodiments. The method 300 includes storing, in a server, a distributed database that includes a plurality of data records, wherein the plurality of data records comprise rental data associated with rental items, as shown in block 302. The method 300, at block 304 includes receiving, from a requestor, an access request for access to the rental data, wherein the rental data includes a price minimum and an availability for each of a plurality of rental locations. Also, the method 300 includes authenticating an identity of the requestor, at block 306. At block 308, the method 300 includes generating a transaction record comprising the identity of the requestor. The method 300 then includes providing, to the requestor, access to the rental data, as shown at block 310. At block 312, the method 300 includes receiving, from the requestor, bid data for a first rental location from the plurality of rental locations, wherein the bid data comprises an ask price for the first rental location. And, at block 314, the method 300 includes comparing the ask price to the price minimum associated with the first rental location to determine an action for the first rental location.

Additional processes may also be included. It should be understood that the processes depicted in FIG. 3 represent illustrations, and that other processes may be added or existing processes may be removed, modified, or rearranged without departing from the scope and spirit of the present disclosure.

A detailed description of one or more embodiments of the disclosed apparatus are presented herein by way of exemplification and not limitation with reference to the Figures.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A computer-implemented method for access control, the method comprising:
storing, in a server, a distributed database that includes a plurality of data records, wherein the plurality of data records comprise rental data associated with rental items;
receiving, from a requestor, an access request for access to the rental data, wherein the rental data includes a price minimum and an availability for each of a plurality of rental locations;
authenticating an identity of the requestor;
providing, to the requestor, access to the rental data;
receiving, from the requestor, bid data for a first rental location from the plurality of rental locations, wherein the bid data comprises an ask price for the first rental location;
generating a transaction record comprising the identity of the requestor and the bid data; and
comparing the ask price to the price minimum associated with the first rental location to determine an action for the first rental location.

2. The method of claim 1, wherein the distributed database is a block chain that receives data from a plurality of entities, the data received for storage is configured to be processed to generate a transaction record that is dependent on previous data stored in the block chain.

3. The method of claim 1, wherein the action comprises accepting the ask price and requesting payment data from the requestor;
receiving, from the requestor, payment data for the first rental location;
adding the bid data and the payment data to the transaction record; and
storing the transaction record in the distributed database.

4. The method of claim 1, wherein the action comprises rejecting the ask price in the bid data based on a determination that the ask price is less than the price minimum associated with the first rental location; and further comprising:
storing the action in the distributed database.

5. The method of claim 1, wherein the action comprises transmitting a price override request to a manager of the first rental location based on a determination that the ask price was less than the price minimum associated with the rental location;
receiving a confirmation of the price override request from the manager and requesting payment data from the requestor;
receiving, from the requestor, payment data for the first rental location;
storing the bid data and the payment data in the transaction record; and
storing the transaction record in the distributed database.

6. The method of claim 3, further comprising:
transmitting the transaction record to the requestor and to an interne-of-things (IoT) device associated with the first rental location.

7. The method of claim 6, wherein the IoT device is an electronic lock at the first rental location.

8. The method of claim 7, wherein the requestor can unlock the electronic lock based on a verification of the identity of the requestor by the electronic lock.

9. The method of claim 6, further comprising:
transmitting a token to the requestor and the IoT device, wherein the token authenticates the requestor.

10. The method of claim 1, wherein the transaction record includes requestor preference data.

11. A system for access control, the system comprising:
a processor communicatively coupled to a server, the processor operable to:
store, in the server, a distributed database that includes a plurality of data records, wherein the plurality of data records comprise rental data associated with rental items;
receive, from a requestor, an access request for access to the rental data, wherein the rental data includes a price minimum and an availability associated with each of a plurality of rental locations;
authenticate an identity of the requestor;
provide, to the requestor, access to the rental data;
receive, from the requestor, bid data for a first rental location, wherein the bid data comprises an ask price for the first rental location;
generate a transaction record comprising the identity of the requestor and the bid data; and
compare the ask price to the price minimum associated with the first rental location to determine an action for the first rental location.

12. The system of claim 11, wherein the distributed database is a blockchain that receives data from a plurality of entities, the data received for storage is configured to be processed to generate a transaction record that is dependent on previous data stored in the blockchain.

13. The system of claim 11, wherein the action comprises accepting the ask price and requesting payment data from the requestor; and the processor is further operable to:
receive, from the requestor, payment data for the first rental location;
add the bid data and the payment data to the transaction record; and
store the transaction record in the distributed database.

14. The system of claim 11, wherein the action comprises rejecting the ask price in the bid data based on a determination that the ask price is less than the price minimum associated with the first rental location; and wherein the processor is further operable to store the action in the distributed database.

15. The system of claim 11, wherein the action comprises transmitting a price override request to a manager of the first rental location based on a determination that the ask price was less than the price minimum associated with the rental location; and the processor is further operable to:
receive a confirmation of the price override request from the manager and requesting payment data from the requestor;
receive, from the requestor, payment data for the first rental location;
store the bid data and the payment data in the transaction record; and
store the transaction record in the distributed database.

16. The system of claim 15, wherein the processor is further operable to:
transmitting the transaction record to the requestor and to an internet-of-things (IoT) device associated with the first rental location.

17. The system of claim 16, wherein the IoT device is an electronic lock at the first rental location.

18. The system of claim 17, wherein the requestor can unlock the electronic lock based on a verification of the identity of the requestor by the electronic lock.

19. A computer-implemented method for access control, the method comprising:
storing, in a memory of a processing server, a distributed database that includes a plurality of data records;
receiving, from a publisher, a request to store a new record to the distributed database;
verifying an identity of the publisher; and
based at least in part on verifying the identity of the publisher, storing the new record to the plurality of data records of the distributed database.

20. The method of claim 19, wherein the distributed database is a block chain that receives data from a plurality of entities, the data received for storage is configured to be processed to generate a transaction record that is dependent on previous data stored in the block chain.
